(19) United States
(12) Patent Application Publication
(10) Pub. No.: US 2025/0284754 A1
(43) Pub. Date: Sep. 11, 2025

(54) Dynamic Locally Cached Point of Interest Object Databases with Content Based on Mobile Device Location and/or User Interests

(71) Applicant: Yellcast, Inc., San Carlos, CA (US)

(72) Inventors: Thomas William Ellenby, San Jose, CA (US); Ganesan Venkatakrishnan, San Carlos, CA (US); Peter Negulescu, San Francisco, CA (US); William Foster, Tucson, AZ (US); Joe S. Abuan, Cupertino, CA (US)

(21) Appl. No.: 19/072,812

(22) Filed: Mar. 6, 2025

Related U.S. Application Data
(60) Provisional application No. 63/562,177, filed on Mar. 6, 2024.

(51) Int. Cl. G06F 16/9537; G06F 16/27

(52) U.S. Cl. CPC G06F 16/9537; G06F 16/27

(57) ABSTRACT

A local object database is populated from a remote object records database. An object has a geolocation representing one or more locations relative to points and/or regions relative to a geographic range of object records. A method might comprise determining a device geolocation state of the mobile device, determining a first geographical search space as a function of device geolocation and range threshold relative to the device geolocation, querying the remote database for a localized subset of object records with geolocations within the first geographical search space, populating the local database with the search results, determining whether the results comprise filterable object records that include a filter parameter, comparing the filter parameter and device geolocation state. When a filterable object record is present in the results and a filter parameter does not match the device geolocation state, the filterable object record is filtered from the local database.

### CROSS-REFERENCES TO PRIORITY AND RELATED APPLICATIONS

This application is a non-provisional of, and claims the benefit of and priority from, U.S. Provisional Patent Application No. 63/562,177 filed Mar. 6, 2024, entitled “Dynamic Locally Cached Point of Interest Object Databases with Content Based on Mobile Device Location and/or User Interests.”

### FIELD

The present disclosure generally relates to providing point-of-interest (POI) items to users of mobile devices and more particularly to selectively providing POI items based on mobile device location and/or user interests.

### BACKGROUND

There arises a need for smart data management for users of mobile devices to prevent them from becoming overloaded with POIs and related data that may be irrelevant to the user based on their current location and defined interests.

### BRIEF DESCRIPTION OF THE DRAWINGS

Various embodiments in accordance with the present disclosure will be described with reference to the drawings, in which:

FIG. 1 is a flowchart illustrating a possible mode of operation of the system associated with access range.

FIG. 2 is a flowchart illustrating a possible mode of operation of the system associated with the location of a mobile device in relation to various geographically-defined areas.

FIG. 3 is a diagram illustrating an example of a possible mode of operation of the system associated with access range.

FIG. 4 is a diagram illustrating an example of a possible mode of operation of the system associated with the location of a mobile device in relation to various geographically-defined areas.

FIG. 5 is a flowchart illustrating a possible mode of operation of the system associated with the bearing from the location of the mobile device to the location of the POI in relation to various reciprocal bearing access angles.

FIG. 6 is a diagram illustrating an example of a possible mode of operation of the system associated with the bearing from the location of the mobile device to the location of the POI in relation to various reciprocal bearing access angles.

FIG. 7 is a diagram illustrating an example of a possible mode of operation of the system involving access range in relation to POIs associated with billboards.

FIG. 8 is a diagram illustrating an example of a possible mode of operation of the system involving access ranges and reciprocal access angles in relation to POIs associated with billboards.

FIG. 9 is a diagram illustrating a possible mode of operation of the system associated with access range and also taking into account geographically-defined intervening areas.

FIG. 10 is a diagram illustrating a possible mode of operation of the system associated with access area and also taking into account geographically-defined intervening areas.

FIG. 11 illustrates an example computer system memory structure as might be used in performing methods described herein, according to various embodiments.

FIG. 12 is a block diagram illustrating an example computer system upon which the systems illustrated in FIGS. 1 and 11 may be implemented, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Using the methods and system described herein, the response time of geographical searches based upon location of a mobile device might be improved, limited off grid access to geolocated information with a mobile device might be implemented, and reduction of geo-clutter or geo-spam might be the case.

A system described herein might comprise one or more servers that are connected over a network with one or more mobile client devices. The system can process localized geolocation information pertaining to objects, either real world or virtual, that have a real-world position. The objects could be natural features, such as mountains, river deltas, trailheads, locations on a feature such as a river that spans a large distance, etc. The objects could be human-made, such as buildings, monuments, plantings, vistas, shops, cultural points of interest, etc. The objects need not have a physical presence involving matter, such as a point 30 meters due west of the intersection of the intersection of Elm Street and Broadway Boulevard where a particular club meets for bird watching.

A data structure describing such an object might comprise fields for describing the object, assigning it to a particular category or class of objects, fields for images depicting the object and/or its environs, and fields indicating its location and/or a particular point of its location (e.g., a large object like an arena can have its location be its geographic center or a point just outside its public entrance. Such a data structure might be represented in computer memory as a point of interest geodescriptor (“POI geodescriptor”). A point of interest (“POI”) database might have a collection of POI geodescriptors, stored as POI geodescriptor records in the POI database.

A user of a mobile device might take steps to include a local POI database on the mobile device. Individual POI geodescriptors might be added and subtracted from a user's local POI database on their mobile device based on their proximity to each object and also dependent on the user's preferences. The system might maintain the local POI database by caching POI geodescriptors from a remote database such that POI geodescriptors that are deemed close to the user's mobile device and delete POI geodescriptors from the local POI database once the system determines that they no longer meet a proximity requirement.

The system might deem a POI geodescriptor to represent an object that is close to the user's mobile device, or deem it not close, based on some proximity requirement determined by a proximity test. In this manner, the system can maintain a local cloud of POIs and related information. The proximity requirement might relate to distance between the mobile device's determined location (which might or might not be its actual current location) and the indicated location indicated in the location field or fields of the object's POI geodescriptor. The proximity requirement might be implemented by, or represented by, a filter parameter or a plurality of filter parameters.

POI geodescriptors might be added to the POI geodescriptor database locally cached on the mobile device as the determined range to the location of the POI is less than an access range associated with that POI or alternatively the determined location of the mobile device is within a geographical access area associated with the POI. These POI geodescriptors are then available to be searched but they are not instantly displayed like spam. This technology would be applicable to GPS-only devices or devices capable of pointing, casting, and/or visual augmented reality.

In addition to objects already known and stored as part of a POI database there are also an increasing number of objects that are transmitting their location and information about where and what they are via RFID, Bluetooth, and other transmission methods, i.e., the Internet of Things (“IoT”). Databases of geolocated objects might comprise records for objects such as restaurants, bars, shops, gas stations etc. An IoT database might contain records for smaller localized static and dynamic geolocated objects such as ATMs, vending machines, store displays, etc., mobile objects such as food trucks or street vendors, and city assets such as street lighting, etc. These IoT objects and related information might also be cached on a user's mobile device and added and subtracted from the locally cached database by comparing the determined range from the location of the mobile device to the location of the IoT object and any related access range threshold.

Access range thresholds or geographical access areas associated with POIs need not be static, i.e., they may be dynamic and responsive to time of day, local weather, time of year, etc.

An example of a Point of Interest geodescriptor (“POI geodescriptor”) might be a data structure that contains stored attributes and information that identify a specific geo-coded object (either real or virtual), i.e., a geolocated Point of Interest (“POI”). In a particular embodiment, the attributes and information might comprise at least:
(a) ID: A unique identifier of the object, e.g., “object 200967”.
(b) Location: A specific location in 3-space in relation to a local coordinate system being used, e.g., latitude, longitude, and altitude, of the primary point reference of the object. The primary point reference of an object might be a center of the object, a point in relation to a feature of the object, such as the public entrance to a building, or some venue-designated point.
(c) Shape/size and orientation: A geometric description of the shape and size of the object, the location of the primary point reference within this geometric description, and the geometric description's orientation to the local coordinate system being used. The shape and/or size of the object can be zero, e.g., a simple point, two-dimensional, i.e., a line segment, or three-dimensional. Examples may be a sphere of a defined radius centered on a primary point reference of the object, or a more complex 3D geometric shape/model located and oriented in relation to the primary point reference and the local coordinate system.
(d) Type: A category of objects the object belongs in. Possible categories may include History, Tourism, Restaurants, Transit, etc. The categories can be variable depending on the application. It should be appreciated that an object could be defined as belonging to two or more categories.
(e) Related Information: The information related to a specific geo-located object such as graphics, audio, etc. This related information may also be a link to a location where such information may be stored remotely.
(f) Access range (if applicable): A range at which the POI geodescriptor of the object will become accessible. Accessibility may trigger the object being added to the cached local POI geodescriptor database.
(g) Geographical access area (if applicable): The geographical area associated with the location of the POI. If a mobile device is determined to be within this geographical area, the POI geodescriptor will become accessible and may be added to the cached local POI geodescriptor database.

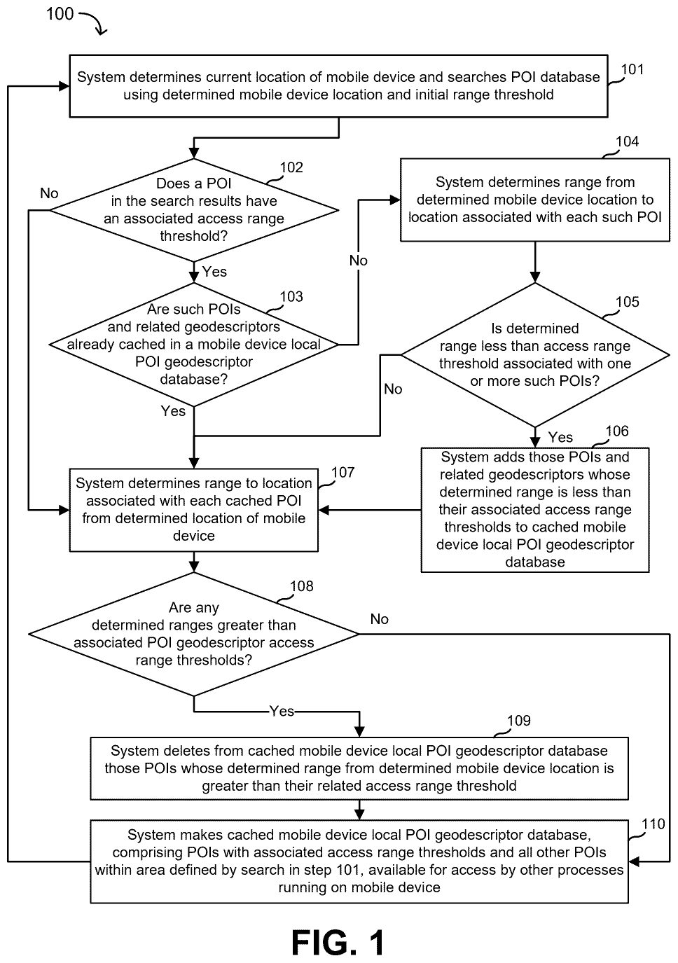

FIG. 1 is a flowchart 100 illustrating a possible mode of operation of the system associated with access range. The system might be a client device or other device mentioned herein. In step 101, the system determines the location of the mobile device and searches a database of POIs using the determined location of the mobile device and an initial range threshold to determine a geographical search area and comparing this search area to the locations associated with the POIs in the database. The flowchart then branches to step 102. In step 102, the system determines if one or more POIs returned as a result in the search performed in step 101 has an associated access range threshold. If the system determines that one or more POIs returned as a result in the search performed in step 101 does not have an associated access range threshold, the flowchart branches to step 107. If the system determines that one or more POIs returned as a result in the search performed in step 101 has an associated access range threshold, the flowchart branches to step 103. In step 103, the system determines if those POIs with related access range thresholds are already cached in the mobile device's local POI geodescriptor database. If the system determines that those POIs with related access range thresholds are already cached in the mobile device's local POI geodescriptor database, the flowchart then branches to step 107. If the system determines that those POIs with related access range thresholds are not already cached in the mobile device's local POI geodescriptor database, the flowchart then branches to step 104.

In step 104, the system determines a range from the determined mobile device position to the location associated with each such POI. The flowchart then branches to step 105. In step 105, the system determines if the determined range to the location associated with one or more such POIs is less than the access range threshold associated with that POI. If the determined range to the location associated with one or more such POIs is not less than the access range threshold associated with that POI, the flowchart then branches to step 107. If the determined range to the location associated with one or more such POIs is less than the access range threshold associated with that POI, the flowchart then branches to step 106.

In step 106, the system adds those POIs and related geodescriptors whose determined range is less than its associated access range threshold to the system's local POI geodescriptor database cached on the mobile device. The flowchart then branches to step 107. In step 107, the system determines the range from the determined location of the mobile device to the location associated with geodescriptors cached in the system's local POI geodescriptor database. The flowchart then branches to step 108. In step 108, the system determines if any ranges, as determined in step 107, are greater than the access range thresholds associated with each specific POI in the system's local POI geodescriptor database. If any such ranges are not greater than the access range thresholds associated with each specific POI in the system's local POI geodescriptor database, then the flowchart branches to step 110. If any such ranges are greater than the access range thresholds associated with each specific POI in the system's local POI geodescriptor database, then the flowchart branches to step 109.

In step 109, the system deletes from the system's local POI geodescriptor database those POIs whose determined range from the determined location of the mobile device is greater than their associated range thresholds. The flowchart then branches to step 110. In step 110, the system makes the system's local POI geodescriptor database, comprising POIs with associated access range thresholds and other POIs within the geographical area defined by the search in step 101, available to other processes, such as location-based search, augmented reality or pointing search, running on the mobile device. The flowchart then branches back to step 101 to continue the filtering process for the system's cached local POI geodescriptor database.

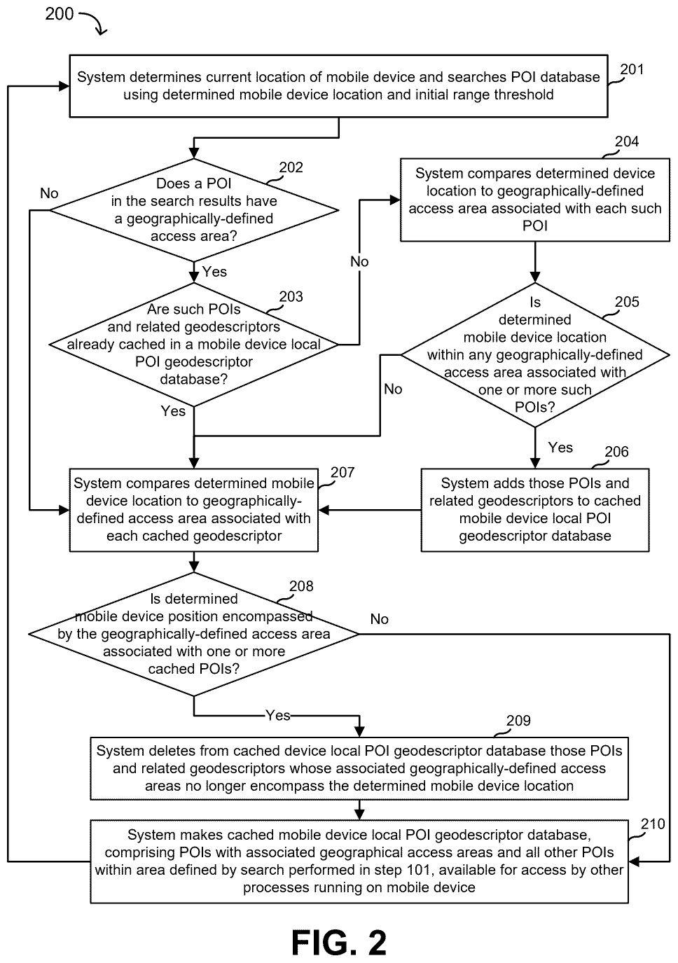

FIG. 2 is a flowchart 200 illustrating a possible mode of operation of the system associated with the location of a mobile device in relation to various geographically-defined access areas. In step 201, the system determines the location of a mobile device and searches a database of POIs using a determined location of the mobile device and an initial range threshold to determine a geographical search area and comparing this search area to the locations associated with the POIs in the database. The flowchart then branches to step 202. In step 202, the system determines if one or more POIs returned as a result in the search performed in step 201 has an associated geographical access area. If the system determines that one or more POIs returned as a result in the search performed in step 201 does not have an associated geographical access area the flowchart branches to step 207. If the system determines that one or more POIs returned as a result in the search performed in step 201 has an associated geographical access area the flowchart branches to step 203.

In step 203, the system determines if those POIs with related geographical access areas are already cached in the mobile device's local POI geodescriptor database. If the system determines that those POIs with related geographical access areas are already cached in the mobile device's local POI geodescriptor database, the flowchart then branches to step 207. If the system determines that those POIs with related geographical access areas are not already cached in the mobile device's local POI geodescriptor database, the flowchart then branches to step 204. In step 204, the system compares the determined mobile device position to the geographical access areas associated with each such POI. The flowchart then branches to step 205. In step 205, the system determines if the geographical access area associated with one or more such POIs encompass the determined position of the mobile device. If the determined location of the mobile device is not encompassed by the geographical access area associated with one or more such POIs the flowchart, then the system branches to step 207. If the determined location of the mobile device is encompassed by the geographical access area associated with one or more such POIs the flowchart, then the system branches to step 206.

In step 206, the system adds those POIs and related geodescriptors whose related geographical access area encompasses the determined location of the mobile device to the system's local POI geodescriptor database cached on the mobile device. The flowchart then branches to step 207. In step 207, the system compares the determined location of the mobile device to the geographical access areas, if any, associated with cached POIs in the system's local POI geodescriptor database. The flowchart then branches to step 208. In step 208, the system determines if the geographical access areas associated with the cached POIs in the system's local POI geodescriptor database encompasses the determined location of the mobile device. If any such geographical access areas associated with each specific POI in the system's local POI geodescriptor database do not encompass the determined position of the mobile device, then the flowchart branches to step 209. If such geographical access areas associated with each specific POI in the system's local POI geodescriptor database do encompass the determined position of the mobile device, then the flowchart branches to step 210.

In step 209, the system deletes from the system's local POI geodescriptor database those POIs whose associated geographical access areas does not encompass the determined location. The flowchart then branches to step 210. In step 210, the system makes the system's local POI geodescriptor database, comprising POIs with associated geographical access areas and other POIs within the geographical area defined by the search in step 201, available to other processes, such as location-based search, augmented reality or pointing search, running on the mobile device. The flowchart then branches back to step 201 to continue the filtering process for the system's cached local POI geodescriptor database.

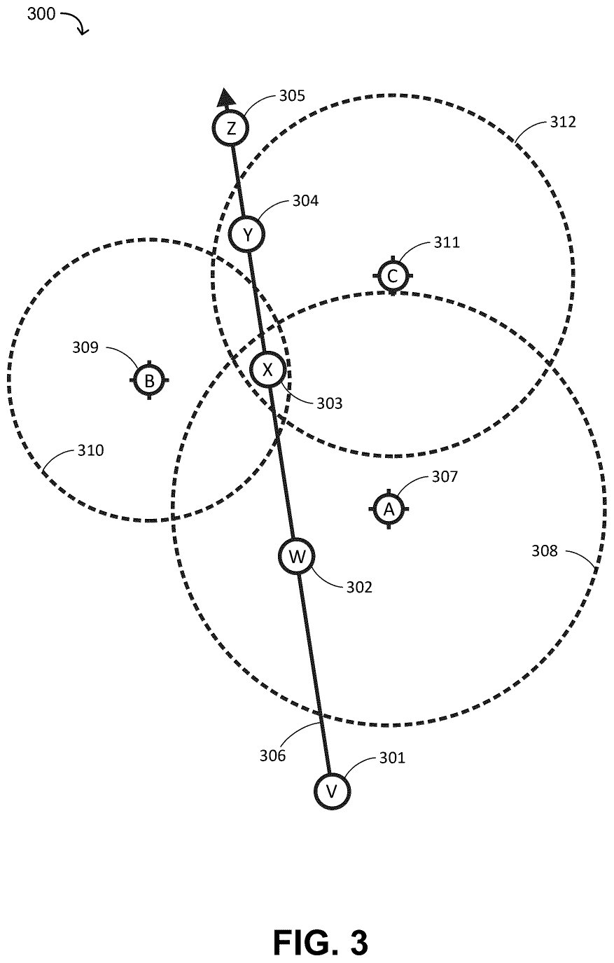

FIG. 3 is a diagram 300 illustrating, in plan view, an example of a possible mode of operation of the system associated with access range as described in FIG. 1 and related text. This example is simplified in that the initial range threshold used to define the search area in relation to the determined position of the mobile device encompasses all POIs (A, B, and C) present in this example. A mobile device is moving along a route 306 and is continually filtering its local cached POI geodescriptor database according to the method described in FIG. 1 and related text. In this example, there are three geodescriptors, A 307, B 309, and C 311, each having an associated access range threshold, 308, 310, and 312, respectively. At determined location V 301, the mobile device has knowledge of POIs A, B, and C having associated locations 307, 309 and 311 and access range thresholds 308, 310 and 312, respectively. Since the range from the determined location V 301 to each of the locations associated with the POIs is greater than all of their respective related access range thresholds the system does not add any POIs to its local cached POI geodescriptor database. At determined location W 302, the system determines that the range from W 302 to the location associated with POI A 307 is less than the access range threshold 308 associated with POI A 307. The system therefore adds POI A to the local cached POI geodescriptor database. At determined location X 303, the system determines that the range from X 303 to the location associated with POIs B 309 and C 311 are less than the respective access range thresholds 310 and 312 associated with each respective POI. The system therefore adds POIs B and C to the local cached POI geodescriptor database. The determined range to the location associated with POI A 307 from determined device position X 303 is still less than the access range threshold 308 associated with POI A and therefore POI A is retained in the local cached POI geodescriptor database. At determined location Y 304, the system determines that the range from determined location Y to the location associated with POIs A and B is greater than their respective access range thresholds and therefore POIs A and B are deleted from the local cached POI geodescriptor database. The determined range from Y 304 to the location associated with POI C is still less than the access range threshold 312 associated with POI C and therefore POI C is retained in the local cached POI geodescriptor database. At determined location Z 305, the determined range to the location associated with POI geodescriptor database C 311 is now greater than the access range threshold 312 associated with POI geodescriptor database C and therefore POI geodescriptor database C is also deleted from the local cached POI geodescriptor database. For this example, the local cached database of geodescriptors would be as follows for each discrete mobile device location;

| | POIs in Mobile Device Cached POI |
|---|---|
| Mobile Device Location | Geodescriptor Database |
| V | — |
| W | A |
| X | A, B, C |
| Y | C |
| Z | — |

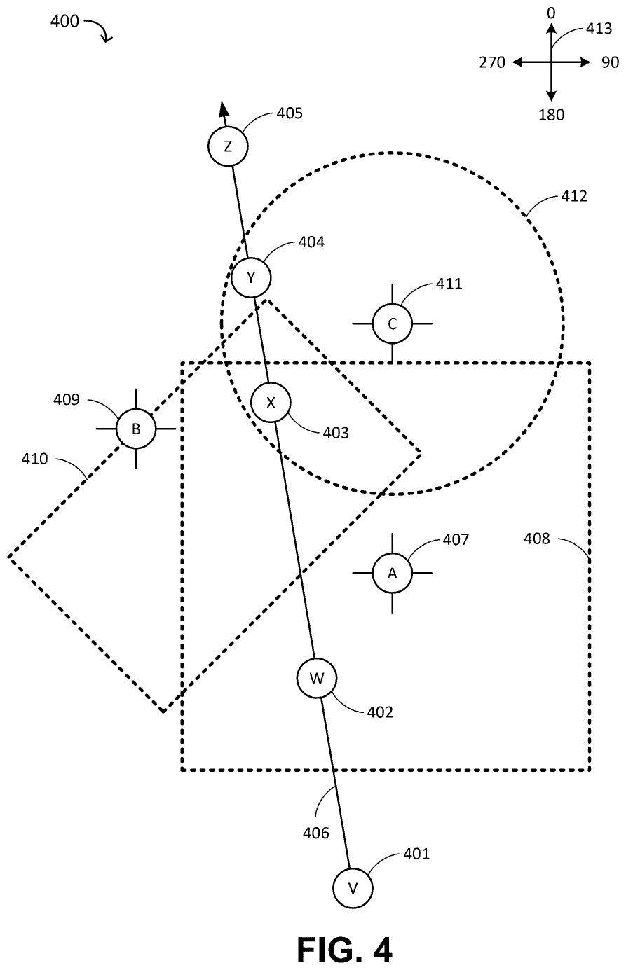

FIG. 4 is a diagram 400 illustrating, in plan view, an example of a possible mode of operation of the system associated with the location of a mobile device in relation to various geographically-defined access areas as described in FIG. 2 and related text. Again, this example is simplified in that the initial range threshold used to define the search area in relation to the determined position of the mobile device encompasses all POIs (A, B, and C) present in this example.

In this example, there are three POIs, A 407, B 409, and C 411, each having an associated geographically-defined access area, 408, 410, and 412 respectively and each respectively oriented in relation to the local coordinate system 413. The geographically-defined access area associated with POI A 407 is a square 408 centered on the location associated with POI A. The geographically-defined access area associated with POI B 409 is a rectangle 410 with location associated with POI A centered on one side of the rectangle and the rectangle having an orientation, i.e., rotation, of 45 degrees in relation to the local coordinate system. The geographically-defined access area associated with POI C 411 is a circle 412 centered on the location associated with POI C. The geographically-defined access area associated with a POI may be of any shape and orientation in relation to the local coordinate system and that the location associated with a POI need not be encompassed by the geographically-defined access area associated with that POI. A mobile device is moving along a route 406 and is continually filtering its local cached POI geodescriptor database of POIs according to the method described in FIG. 2 and related text. In some cases, a center location need not be in a geographic center of its respective geographically-defined access area.

At determined location V 401, the mobile device is receiving information relating to POI A, B, and C having associated locations 407, 409 and 411 and geographically-defined access areas 408, 410 and 412, respectively. Since the determined location V 401 is not encompassed by any geographically-defined access areas associated with POIs A, B or C the system does not add any geodescriptors to its local cached POI geodescriptor database. At determined location W 402, the system determines that current determined location 402 is encompassed by the geographically-defined access area 408 associated with POI A. The system therefore adds POI A to the local cached POI geodescriptor database. At determined location X 403, the system determines that current determined location 403 is encompassed by the geographically-defined access areas 410 and 412 associated with POI B and C, respectively. The system therefore adds POIs B and C to the local cached POI geodescriptor database. The determined position X 403 is still encompassed by the geographically-defined access area 408 associated with POI A 407 and therefore POI A is retained in the local cached POI geodescriptor database.

At determined location Y 404, the system determines that the geographically-defined access areas associated with POIs A and B does not encompass determined location Y 404 and therefore POIs A and B and related information are deleted from the local cached POI geodescriptor database. The geographically-defined access area 412 associated with POI C does encompass the determined device location Y and therefore POI C is retained in the local cached POI geodescriptor database. At determined location Z 405, the geographically-defined access area associated with POI C 411 no longer encompasses the determined device location Z 405 and therefore POI C and related information is also deleted from the local cached POI geodescriptor database. For this example, the local cached POI geodescriptor database would be as follows for each discrete mobile device location:

| | POI in Device Local Cached POI |
|---|---|
| Mobile Device Location | Geodescriptor Database |
| V | — |
| W | A |
| X | A, B, C |
| Y | C |
| Z | — |

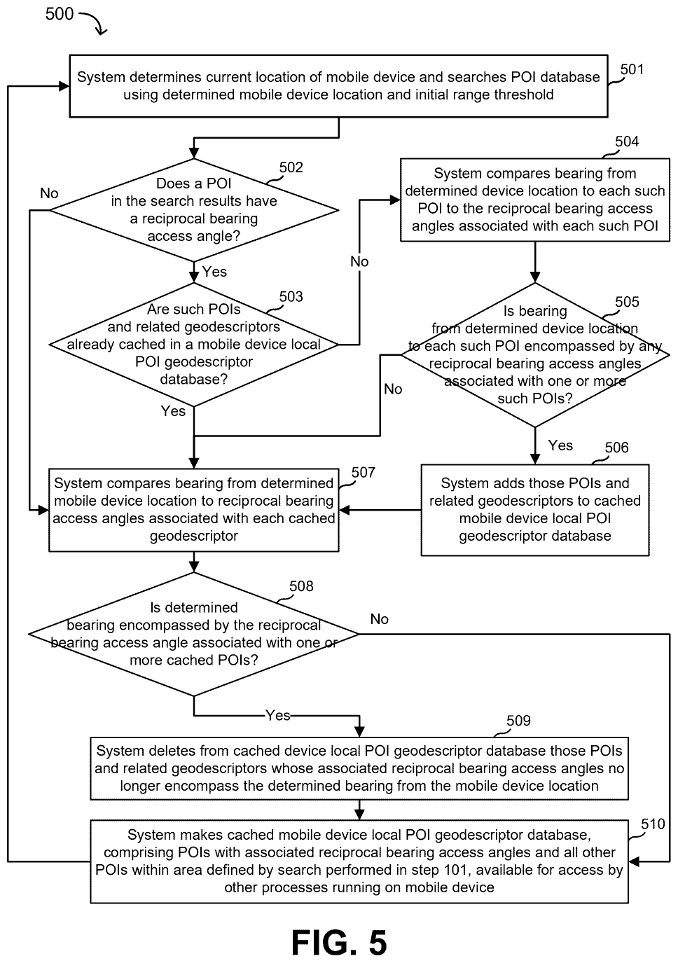

FIG. 5 is a flowchart 500 illustrating a possible mode of operation of the system associated with the location of a mobile device in relation to various reciprocal bearing access angles. An example of a reciprocal angle is as follows; if a vector from location A to location B is 135 degrees, then the reciprocal of that angle (and the direction location A is from location B) is 315 degrees. In step 501, the system determines the location of the mobile device and searches a database of POIs using the determined location of the mobile device and an initial range threshold to determine a geographical search area and comparing this search area to the locations associated with the POIs in the database. The flowchart then branches to step 502. In step 502, the system determines if one or more POIs returned as a result in the search performed in step 501 has an associated reciprocal bearing access angle. If the system determines that one or more POIs returned as a result in the search performed in step 501 does not have an associated reciprocal bearing access angle the flowchart branches to step 507. If the system determines that one or more POIs returned as a result in the search performed in step 501 has an associated reciprocal bearing access angle the flowchart branches to step 503.

In step 503, the system determines if those POIs with related reciprocal bearing access angles are already cached in the mobile device's local POI geodescriptor database. If the system determines that those POIs with related reciprocal bearing access angles are already cached in the mobile device's local POI geodescriptor database, the flowchart then branches to step 507. If the system determines that those POIs with related reciprocal bearing access angles are not already cached in the mobile device's local POI geodescriptor database, the flowchart then branches to step 504. In step 504, the system compares the determined mobile device position to the reciprocal bearing access angle(s) associated with each such POI. The flowchart then branches to step 505. In step 505, the system determines if the reciprocal bearing access angle associated with one or more such POIs encompasses the determined position of the mobile device by calculating the angle of a vector from the determined location of the mobile device, calculating the reciprocal of that vector and determining if that reciprocal angle is encompassed by the reciprocal bearing access angle associated with that POI. If the determined location of the mobile device is not encompassed by the reciprocal bearing access angle associated with one or more such POIs the flowchart, the flowchart then branches to step 507. If the determined location of the mobile device is encompassed by the reciprocal bearing access angle associated with one or more such POIs the flowchart, the flowchart then branches to step 506. In step 506, the system adds those POIs and related geodescriptors whose related reciprocal bearing access angle encompasses the determined location of the mobile device to the system's local POI geodescriptor database cached on the mobile device. The flowchart then branches to step 507. In step 507, the system compares the determined location of the mobile device to the reciprocal bearing access angles, if any, associated with cached POIs in the system's local POI geodescriptor database. The flowchart then branches to step 508. In step 508, the system determines if the reciprocal bearing access angles associated with the cached POIs in the system's local POI geodescriptor database encompass the determined location of the mobile device. If any such reciprocal bearing access angles associated with each specific POI in the system's local POI geodescriptor database do not encompass the determined position of the mobile device, then the flowchart branches to step 509. If all such reciprocal bearing access angles associated with each specific POI in the system's local POI geodescriptor database do encompass the determined position of the mobile device, then the flowchart branches to step 510. In step 509 the system deletes from the system's local POI geodescriptor database those POIs whose associated reciprocal bearing access angle does not encompass the determined location. The flowchart then branches to step 510. In step 510, the system makes the system's local POI geodescriptor database, comprising POIs with associated reciprocal bearing access angles and other POIs within the geographical area defined by the search in step 501, available to other processes, such as location-based search, augmented reality or pointing search, running on the mobile device. The flowchart then branches back to step 501 to continue the filtering process for the system's cached local POI geodescriptor database.

The methods described in FIGS. 1, 2, and 5 could run in series or in parallel to filter a local cached database of POI geodescriptors for access range, geographical access areas, and/or reciprocal access angles associated with POIs. One possible arrangement would be to run the methods in series, in which case the flowcharts would branch from step 110 to step 202 (the location of the mobile device having already been determined by the system so step 201 becomes unnecessary) rather than step 101, and from step 210 to step 301, etc.

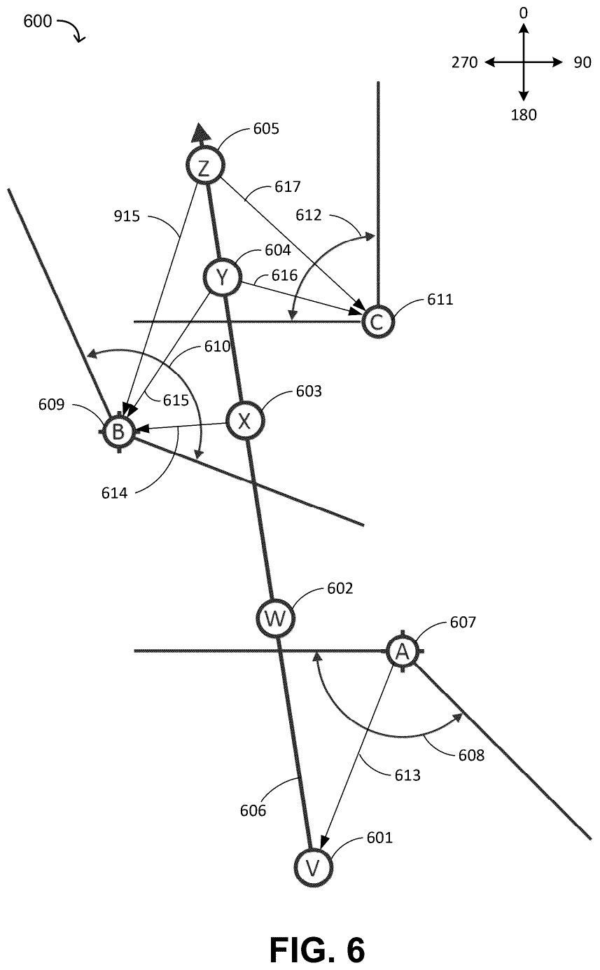

FIG. 6 is a diagram 600 illustrating, in plan view, an example of a possible mode of operation of the system associated with reciprocal bearing access angles as described in FIG. 5 and related text. This example is simplified in that the initial range threshold used to define the search area in relation to the determined position of the mobile device encompasses all POIs (A, B, and C) present in this example.

A mobile device is moving along a route 606 and is continually filtering its local cached POI geodescriptor database according to the method described in FIG. 5 and related text. In this example there are three geodescriptors, A 607, B 609, and C 611, each having an associated reciprocal bearing access angle, 608, 610, and 612, respectively. At determined location V 601, the mobile device has knowledge of POIs A, B, and C having associated locations 607, 609 and 611 and reciprocal bearing access angles 608, 610 and 612, respectively. At determined location V 601, the reciprocal vector 613 from geodescriptor A 607 to the determined location V 601 is encompassed by the reciprocal bearing access angle 608 associated with geodescriptor A 607 and hence the system adds POI A to the local cached POI geodescriptor database. At determined location W 602, the reciprocal bearing access angles 608, 610, 612 related to geodescriptors A 607, B 609, and C 611 do not encompass the reciprocal vectors (not shown for simplicity) from location W 602 the system removes POI A 607 from the local cached POI geodescriptor database. At determined location X 603, the reciprocal vector 614 from geodescriptor B 609 to the determined location X 603 is encompassed by the reciprocal bearing access angle 610 associated with geodescriptor B 609 and hence the system adds POI B to the local cached POI geodescriptor database. At determined location Y 604, the reciprocal vectors 615, 616 from geodescriptors B 609 and C 611 respectively to the determined location Y 604 are encompassed by the reciprocal bearing access angles 610, 612 associated with geodescriptor B 609 and C 611 respectively and hence the system adds POI C to the local cached POI geodescriptor database. At location Z 605, the reciprocal vectors 615 and 617 are still encompassed by the reciprocal bearing access angles 610, 611 associated with geodescriptors B 609 and C 611 and hence no change is made to the local cached POI geodescriptor database.

| | POIs in Mobile Device Cached POI |
|---|---|
| Mobile Device Location | Geodescriptor Database |
| V | A |
| W | — |
| X | B |
| Y | B, C |
| Z | B, C |

For an example of the system in use, suppose a user using a mobile device is running an augmented reality (“AR”) application to explore their surroundings. AR can use the device's position and pointing direction to determine an object being addressed and layers that information in the form of computer-generated graphics over a live camera feed onto the device's display. The user might have indicated an interest in vending machines and ATMs and these objects are not generally found in geo-located object databases. Vending machines and ATMs might be equipped with some form of wireless transmitter that broadcasts information pertaining to itself to the surrounding area. This information might include the object's location, its latitude and longitude, possibly the closest street location, type of object (e.g., soda machine, snack machine, a particular bank's ATM, etc.). When the determined location of the mobile device comes into the proximity threshold, they receive the data from the individual transmitters and cache the information pertaining to each individual object. The user of the mobile device will not be presented with this information until they query their surroundings with their AR application. In this manner, the information presented is passive and not pushed on to the user.

Once a particular object is out of range (this range could be determined in a number of ways including but not limited to, a geolocated area associated with each object or it could simply be the range of the transmitter for each object) the object and its associated geodescriptor information is removed from the mobile device's locally cached database.

It is possible that people and their locations, a human geo-descriptor, could also be utilized by the system. The location of police in closest relation to a user would be a good example of a system that utilized a person's geo-descriptor information in cached dynamic databases relating to the user's proximity to the people that meet their interest criteria. Another example is friends who are within one mile may be added to the cached database and then removed when they are further away than one mile.

Each object and its geo-descriptor could have a unique threshold. For example, a soda machine may be included in a user's dynamic cached database if the user is within 60 feet of the machine and a food truck may be within a user's dynamic cached database if they are within 2 miles of the food truck. It could also be the case that the shape that determines if an object is close enough to a user may not always be a circle. It may be a square, a triangle, or any number of shapes. It is also possible that in urban environments the shape could be three dimensional. A snack machine on the third floor of a building may have a shape that extends three floors down and also three floors up. Another example of a differing shape may be an object that is inaccessible to people at certain angles of address to an object. If there is a food truck just 60 feet from a user but is on the other side of a freeway with no way to cross, then the food truck's shape of address would exclude the freeway and also the neighborhood on the other side. In that case, this object would not be placed into a user's cached dynamic database unless they were to cross the freeway and come within the proximity threshold that would cause the system to add the object to their cached database.

Time may also be a factor in determining which geodescriptors are added to or subtracted from the cached local POI geodescriptor database. For example, a POI geodescriptor associated with a news agent may only be accessible, even if the determined location of the mobile device is within the associated access range, during normal business hours. Alternatively in this example the geodescriptor itself may be accessible but the external information that the geodescriptor points to may be time sensitive, i.e., during normal business hours the user may be directed to a web page that describes specials available that day and during other hours the user may be directed to the home page of the establishment. Some POIs may have a time component as part of their geodescriptor that limits the information available until a set time and date or window of time is reached, e.g., the user may only get a “Big News Coming Soon” message, i.e., something is going to happen at that location but the specifics are not yet available, when accessing such a geodescriptor unless the determined time meets the parameters required by that particular geodescriptor for access to more information.

Another use of time may be to give the user of such a system the ability to adjust a query by altering the time that is searched, e.g., the user instructs the system to search for POIs that will be accessible in six hours or were accessible six hours ago. Motion or route of known mobile POIs, such as vehicles (food trucks, buses, etc.) can be deemed to be time-sensitive and therefore the location of POIs such as these might be tracked by an administrator of the macro POI database over time and, given that each update of the mobile device cached local POI geodescriptor database using the methods described herein in effect a snapshot of a static POI database, the motion of such mobile POIs, while relevant to the caching system, need not be tracked by the caching system.

### Billboard Example

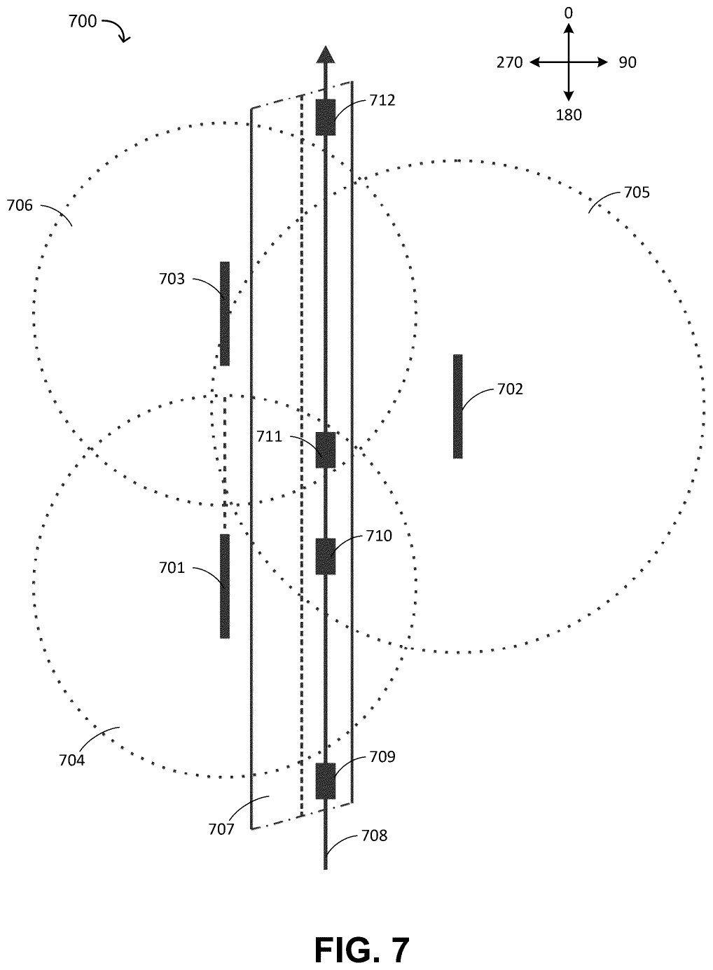

FIG. 7 is a plan view 700 of an example scene comprising a roadway 707, a billboard 701 with an associated geodescriptor that includes an access range 704, a billboard 702 with an associated geodescriptor that includes an access range 705, a billboard 703 with an associated geodescriptor that includes an access range 706, and various locations of a car 709, 710, 711, 712 as it travels along a route 708 on roadway 707.

The relative access range associated with each billboard can be distinct from a transmission range (Bluetooth/Wi-Fi/etc.) of a transmitter (Bluetooth/Wi-Fi/etc.) possibly collocated with the billboard but is instead a range at which the information associated with the billboard becomes relevant to a user of the mobile device. The information relating to each billboard may be ignored by a mobile device until the determined range from the mobile device to that billboard is determined to be less that the access range associated with each billboard. When “in range”, the information associated with that billboard may be added to a local cached database on the mobile device for later access or may simply become “visible” to the device when “in range” and accessible via the cloud. In a particular embodiment, the decision of whether a POI is visible might be done according to one or more of these considerations:
(a) When the car is at location 709, the determined ranges to the three billboards are greater than the associated access ranges and therefore the information relating to those billboards is not accessible by the mobile device.
(b) When the car is at location 710, the ranges to billboards 701, 702 are less than their associated access ranges and therefore the information relating to those billboards is accessible by the mobile device.
(c) When the car is at location 711, the range to each billboard is less than all associated access ranges and therefore the information relating to billboards 701, 702, 703 is accessible by the mobile device.
(d) When the car is at location 712, the range to each billboard is greater than all associated access ranges and therefore the information relating to billboards 701, 702, 703 is no longer accessible by the mobile device.

A geodescriptor may also include a reciprocal bearing access angle, to provide for filtering of an object based not only whether the object is in range, but whether the mobile device is within a limited certain range of bearing relative to the object. An example might be a billboard that is only visible from, and therefore relevant to, a mobile device located at a position from which the billboard is visible by the mobile device.

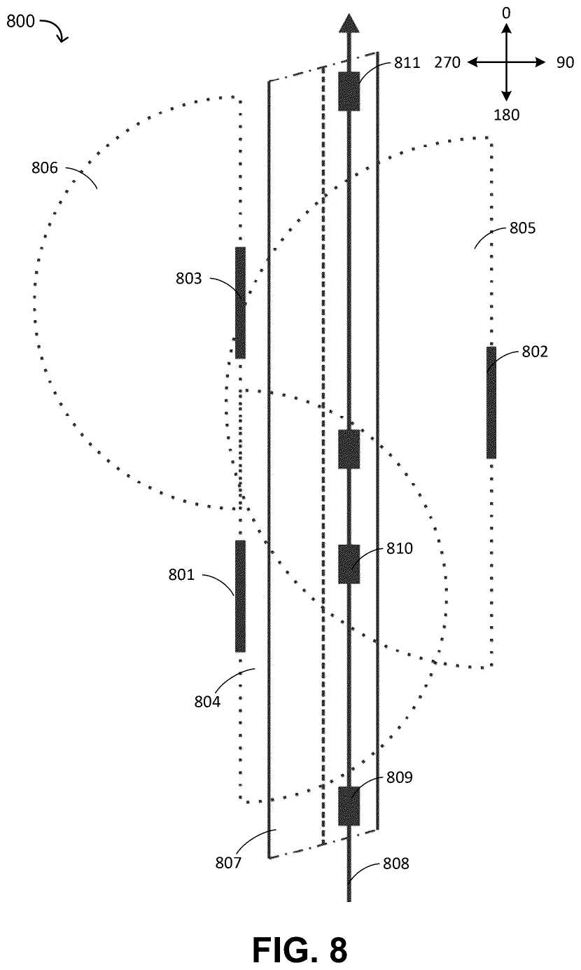

FIG. 8 is a plan view 800 of the same scene as illustrated in FIG. 7, but with each billboard geodescriptor also including a reciprocal bearing access angle, comprising a roadway 807, a billboard 801 with an associated geodescriptor that includes an access range and a reciprocal bearing access angle of from 0-179 degrees that defines an area 804 from which the geodescriptor must be addressed in order to access the information associated with that geodescriptor, a billboard 802 with an associated geodescriptor that includes an access range and a reciprocal bearing access angle of from 180-359 degrees that defines an area 805 from which the geodescriptor must be addressed in order to access the information associated with that geodescriptor, a billboard 803 with an associated geodescriptor that includes an access range and a reciprocal bearing access angle of from 180-359 degrees that defines an area 806 from which the geodescriptor must be addressed in order to access the information associated with that geodescriptor, along with various locations of a car 809, 810, 811, 812 as it travels along a route 808 on the roadway 807.

The system might operate to filter or not filter POIs of the billboards. For example, when the car is at location 809, the determined ranges to the three billboards are greater than the associated access ranges and therefore the information relating to those billboards is not accessible by the mobile device and so those might be excluded. When the car is at location 810 the ranges to billboards 801, 802 are less than their associated access ranges and the reciprocals of the relative bearings from location 810 to billboards 801, 802 are approximately 105 degrees and 240 degrees, respectively. Therefore, since both billboards are within range and the access angle is within the predefined tolerance, the information relating to those billboards is accessible by the mobile device. When the car is at location 811, the range to each billboard is greater than all associated relative range restrictions and therefore the information relating to billboards 801, 802, 803 is no longer accessible by the mobile device. The information relating to the billboard 803 would not be accessible from any location on the roadway since the combination of its associated access range and reciprocal access angle define an area that does not encompass the roadway 807 or the route traveled by the car 808.

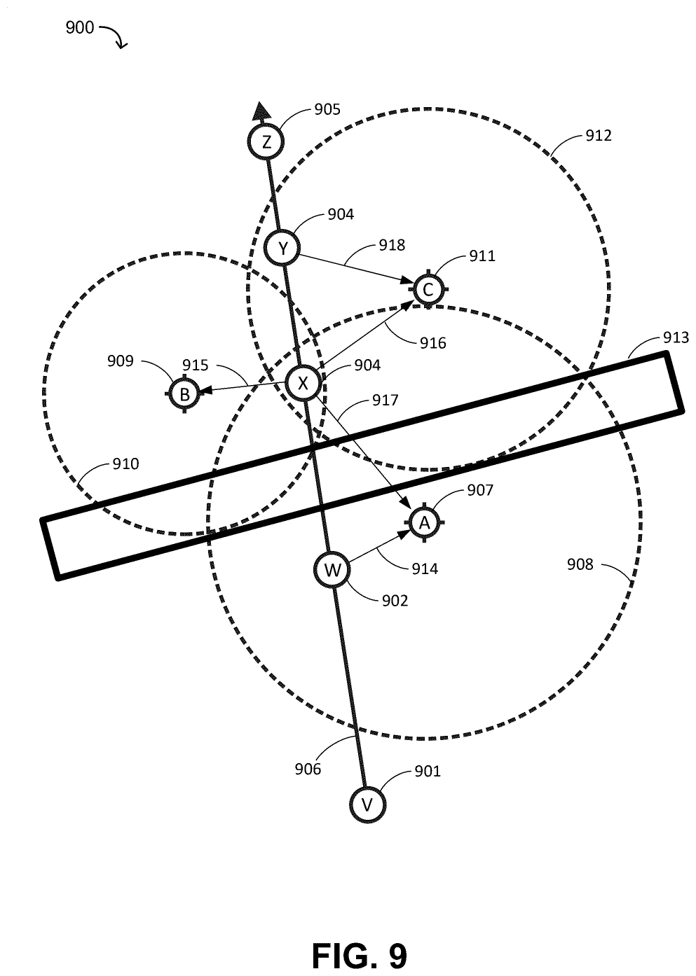

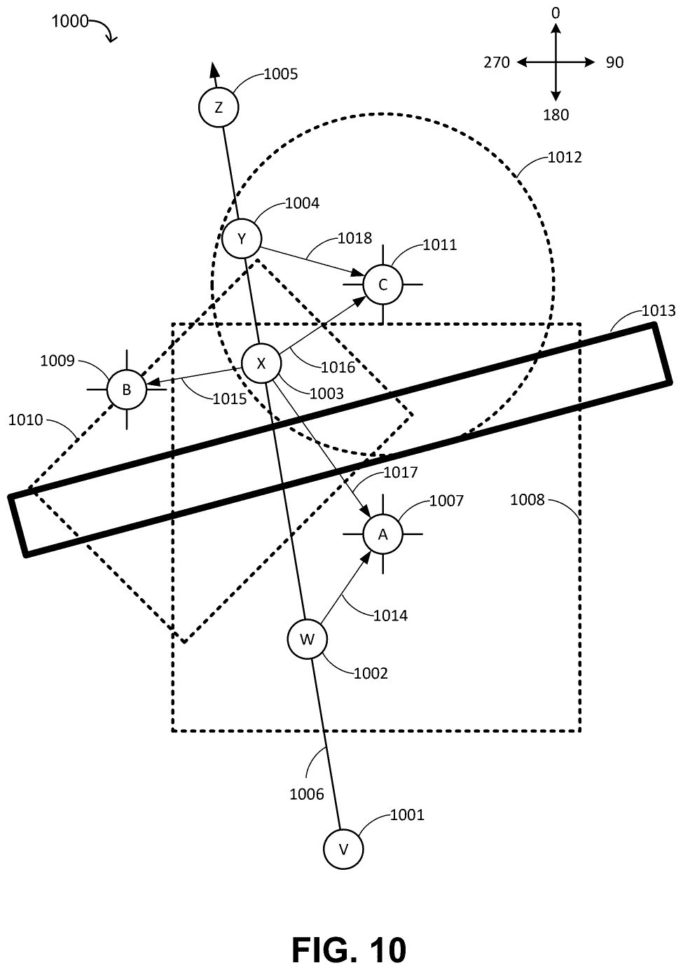

Variability of access range, geographical access area, and/or reciprocal bearing access angle (herein collectively known as the “access characteristics”) might be considered. The access characteristics associated with a POI may be variable in relation to various parameters. Some examples might be:
Time of day, e.g., day/night. For example, an access range relating to a billboard POI may be 500 meters during daylight hours but is reduced by 50% to 250 meters during the evening hours.
Time of year/specific dates, e.g., the access range associated with a specific type of POI may be increased by 50% during a specific range of dates, i.e., a commerce-type POI may have its access range increased during the holiday period of December 15th though January 2nd.
Local weather. For example, an access range associated with a POI may be reduced by 25% if it is raining at that location.
Ambient light levels. For example, the access range associated with a POI may be reduced by 75% if the local ambient light is below a defined threshold, i.e., it is getting darker at that location. The ambient light level need not be dependent on time of day. Light levels may be affected by other factors, such as heavy cloud cover.
Time to get to POI from determined location exceeds a pre-set time threshold. While a POI may be in range, the time for the user to transit from their current location to the location of the POI may be prohibitive. This would also be dependent on the current mode of travel of user (walking, driving, public transport, etc.).
User indication of interest. E.g., a user has indicated that they are interested in ATMs and consequently POIs that are identified as ATMs would have their access range increased by 50% or some other percentage.
Intervening terrain or other geographically-defined areas. E.g., a river is between the determined position of the mobile device and a POI (i.e., the vector from the determined position of the mobile device to the POI crosses the geographical area that defines the river) and the access range for that POI is consequently reduced by 100% and hence it will not be added to cached database since it would be inaccessible to the user even if it was within range. Other types of blocking “terrain” might include roads/freeways, international borders, restricted/secure areas, or routes, etc. Possible modes of operation and consideration of access ranges and access areas are described in connection with FIGS. 9, 10 and related text below.

Variability of access characteristics may be a 1) simple yes/no, i.e., it is or is not available depending on different criteria, or 2) reduced or increased by a percentage of the original (e.g., 50%, 30%, 140%, etc.). While reducing or increasing by a percentage of the original might apply quite easily to access ranges or reciprocal bearing access angles, it can be more complicated to apply to access areas but can still be done. For example, a rule may be that access areas associated with a geolocated POI the access area may be uniformly reduced (i.e., scaled down) in regard to various criteria up to the point where the geolocated POI is no longer within the reduced access area, at which point the access area would be eliminated entirely.

The number of the various access characteristics associated with a POI may also be variable depending on various criteria. As an example, a billboard POI may be double-sided during the day but only single-sided at night.

FIG. 9 is a diagram 900 illustrating a possible mode of operation of the system associated with access range and also taking into account geographically-defined intervening areas. The motion of the mobile device from location V 901 to location Z 905 and the locations of the geodescriptors A 907, B 909, and C911 might be as described in FIG. 3 and associated text, with the addition of an area of a geographically-defined intervening area 913. A mobile device is moving along a route 906 and is continually filtering its local cached POI geodescriptor database. In this example, there are three geodescriptors, A 907, B 909, and C 911, each having an associated access range threshold, 908, 910, 912, respectively. At determined location V 901, the mobile device has knowledge of POIs A, B, and C having associated locations 907, 909 and 911 and access range thresholds 908, 910 and 912, respectively. Since the range from the determined location V 901 to each of the locations associated with the POIs is greater than all of their respective related access range thresholds, the system does not add any POIs to its local cached POI geodescriptor database.

At determined location W 902, the system determines that the range from W 902 to the location associated with POI A 907 is less than the access range threshold 908 associated with POI A 907 and that the vector 914 from W 902 to POI A 907 does not intersect the geographically-defined intervening area 913. The system therefore adds POI A to the local cached POI geodescriptor database. At determined location X 903, the system determines that the ranges from X 903 to the locations associated with POIs A 907, B 909 and C 911 are less than the respective access range thresholds 908, 910 and 912 associated with each respective POI. In addition, the system determines that, while the vectors 915, 916 from location X 904 to POIs B 909 and C 911 respectively do not intersect the geographically-defined intervening area 913, the vector 917 from location X to POI A does intersect geographically-defined intervening area 913. The system therefore adds POIs B and C to the local cached POI geodescriptor database and removes POI A from the local cached POI geodescriptor database. At determined location Y 904, the system determines that the range from determined location Y to the location associated with POI B is greater than the access range threshold 910 and therefore POI B is deleted from the local cached POI geodescriptor database. The determined range from Y 904 to the location associated with POI C is still less than the access range threshold 912 associated with POI C and the vector 918 from location Y 904 to POI C 911 does not intersect the geographically-defined intervening area 913 and therefore POI C is retained in the local cached POI geodescriptor database.

At determined location Z 905, the determined range to the location associated with POI geodescriptor database C 911 is now greater than the access range threshold 912 associated with POI geodescriptor database C and therefore POI geodescriptor database C is also deleted from the local cached POI geodescriptor database. For this example, the local cached database of geodescriptors would be as follows for each discrete mobile device location;

| | POIs in Mobile Device Cached POI |
|---|---|
| Mobile Device Location | Geodescriptor Database |
| V | — |
| W | A |
| X | B, C |
| Y | C |
| Z | — |

FIG. 10 is a diagram 1000 illustrating a possible mode of operation of the system associated with access areas and also taking into account geographically-defined intervening areas. The motion of the mobile device from location V 1001 to location Z 1005 and the locations of the geodescriptors A 1007, B 1009, and C 1011 might be as described in FIG. 4 and associated text with the addition of a geographically-defined intervening area 913. A mobile device is moving along a route 1006 and is continually filtering its local cached POI geodescriptor database. In this example, there are three geodescriptors, A 1007, B 1009, and C 1011, each having an associated access area, 1008, 1010, 1012, respectively. At determined location V 1001, the mobile device has knowledge of POIs A, B, and C having associated locations 1007, 1009 and 1011 and access areas 1008, 1010, 1012, respectively. Since the determined location V 1001 is not encompassed by any of the access areas 1001, 1010, 1012 associated with POIs A 1007, B 1009, or C 1011, the system does not add any POIs to its local cached POI geodescriptor database. At determined location W 1002, the system determines that location W 1002 is incorporated by access area 1008 associated with POI A 1007 and that vector 1014 from W 1002 to POI A 1007 does not intersect geographically-defined intervening area 1013. The system therefore adds POI A to the local cached POI geodescriptor database.

At determined location X 1003, the system determines that location X 1003 is incorporated by the respective access areas 1008, 1010 and 1012 associated with each respective POI. In addition, the system determines that, while vectors 1015, 1016 from location X 1004 to POIs B 1009 and C 1011 respectively do not intersect geographically-defined intervening area 1013, vector 1017 from location X to POI A does intersect geographically-defined intervening area 1013. The system therefore adds POIs B and C to and removes POI A from the local cached POI geodescriptor database. At determined location Y 1004, the system determines that location Y is no longer encompassed by access area 1010 associated with POI B 1009, and therefore POI B is deleted from the local cached POI geodescriptor database. Location Y 1004 is still encompassed by access area 1012 associated with POI C and vector 1018 from location Y 1004 to POI C 1011 does not intersect geographically-defined intervening area 1013 and therefore POI C is retained in the local cached POI geodescriptor database. At determined location Z 1005, the location of the mobile device is no longer encompassed by access area 1012 associated with POI C and therefore POI C is also deleted from the local cached POI geodescriptor database. For this example, the local cached database of geodescriptors would be as follows for each discrete mobile device location.

| | POIs in Mobile Device Cached POI |
|---|---|
| Mobile Device Location | Geodescriptor Database |
| V | — |
| W | A |
| X | B, C |
| Y | C |
| Z | — |

While FIGS. 3, 4, and 6-10 show possible modes of operation of the system in plan view, i.e., 2D as viewed from directly above, it should be appreciated that an access range threshold, geographical access area, or reciprocal bearing access angle associated with a specific POI may also be a three-dimensional construct, i.e., of a defined shape, e.g., a cube, sphere, etc., and orientation located in a defined way in relation to the location associated with that POI. While routes 306, 406, 606 708, 808, 906, and 1006 taken by the mobile device in the examples illustrated in FIGS. 3, 4, and 6-10 is, for simplicity of explanation, a straight line, a route may of course be much more complex. The system is illustrated as operating at discrete locations along the route but could be constantly filtering the local cached POI geodescriptor database as the mobile device's determined location changes.

While the examples of the system in operation described above show each POI having a single access range, access area or reciprocal access angle associated with it, it may also be true that a single POI may have more than one of each type associated with it. For example, in the billboard scenario described in FIGS. 8-9 and related text, billboard 803 is shown with its access area 806 defined by its access range and reciprocal access angle as being only accessible when not on roadway 807, but in an alternate scenario billboard 803 may have a second access area relating to a second set of information that is accessible from the roadway.

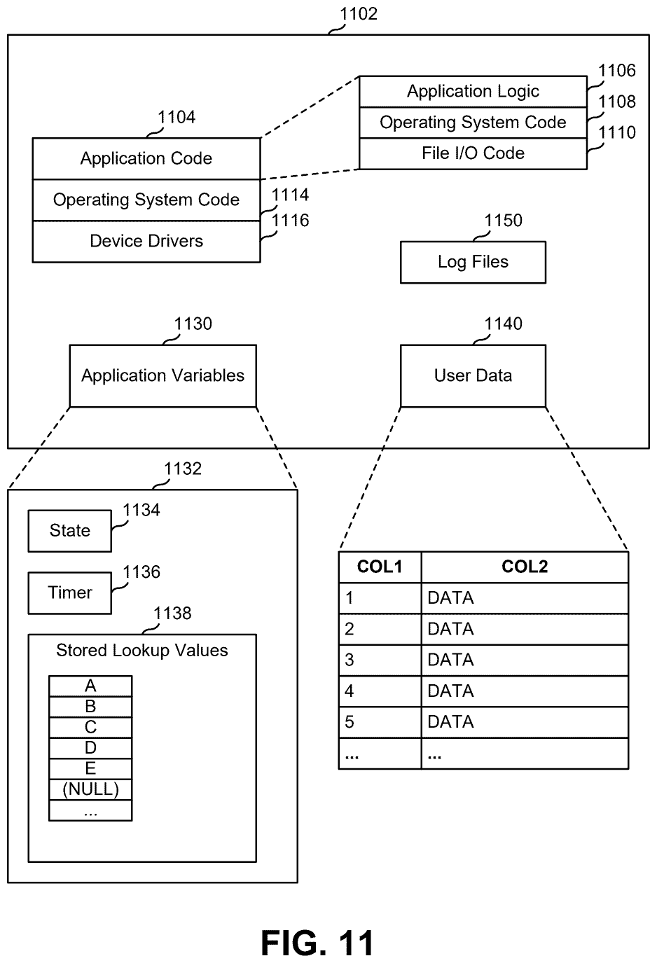

FIG. 11 is a simplified functional block diagram of a storage device 1102 having an application that can be accessed and executed by a processor in a computer system as might be part of embodiments of the system described herein and/or a computer system that performs operations described herein. FIG. 11 also illustrates an example of memory elements that might be used by a processor to implement elements of the embodiments described herein. In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 1102 can be one or more memory device that can be accessed by a processor and storage device 1102 can have stored thereon application code 1104 that can be one or more processor readable instructions, in the form of write-only memory and/or writable memory. Application code 1104 can include application logic 1106, library functions 1108, and file I/O functions code 1110 associated with the application. The memory elements of FIG. 11 might be used for a server or computer that interfaces with a user, generates data, and/or manages other aspects of a process described herein. In addition to application code 1104, storage device 1102 might also contain operating system code 1114 and device drivers 1116.

Storage device 1102 can also include storage for application variables 1130 that can include one or more storage locations configured to receive variables 1132. Application variables 1130 can include variables that are generated by the application or otherwise local to the application, such as state variables 1134, timers 1136, and/or stored lookup values 1138. Application variables 1130 can be generated, for example, from data retrieved from an external source, such as a user or an external device or application. A processor can execute application code 1104 to generate application variables 1130 provided to storage device 1102. Application variables 1130 might include operational details needed to perform the functions described herein.

Storage device 1102 can include storage for databases and other data described herein. One or more memory locations can be configured to store user data 1140, which might include data sourced by an external source, such as a user or an external device. User data 1140 can include, for example, records being passed between servers prior to being transmitted or after being received. Other data might also be supplied.

Storage device 1102 can also include log files 1150 having one or more storage locations configured to store results of the application or inputs provided to the application. For example, log files 1150 can be configured to store a history of actions, alerts, error messages, and the like.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

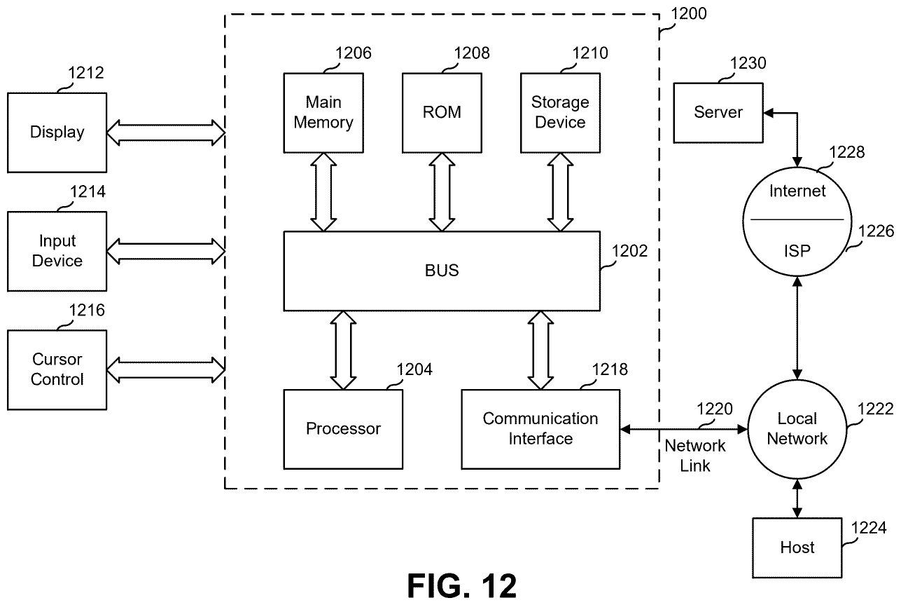

FIG. 12 is a block diagram that illustrates a computer system 1200 upon which the computer systems of the systems described herein and/or data structures shown in FIG. 11 may be implemented. Computer system 1200 includes a bus 1202 or other communication mechanism for communicating information, and a processor 1204 coupled with bus 1202 for processing information. Processor 1204 may be, for example, a general-purpose microprocessor.

Computer system 1200 also includes a main memory 1206, such as a random-access memory (RAM) or other dynamic storage device, coupled to bus 1202 for storing information and instructions to be executed by processor 1204. Main memory 1206 may also be used for storing temporary variables or other intermediate information during execution of instructions to be executed by processor 1204. Such instructions, when stored in non-transitory storage media accessible to processor 1204, render computer system 1200 into a special-purpose machine that is customized to perform the operations specified in the instructions.

Computer system 1200 further includes a read only memory (ROM) 1208 or other static storage device coupled to bus 1202 for storing static information and instructions for processor 1204. A storage device 1210, such as a magnetic disk or optical disk, is provided and coupled to bus 1202 for storing information and instructions.

Computer system 1200 may be coupled via bus 1202 to a display 1212, such as a computer monitor, for displaying information to a computer user. An input device 1214, including alphanumeric and other keys, is coupled to bus 1202 for communicating information and command selections to processor 1204. Another type of user input device is a cursor control 1216, such as a mouse, a trackball, or cursor direction keys for communicating direction information and command selections to processor 1204 and for controlling cursor movement on display 1212. This input device typically has two degrees of freedom in two axes, a first axis (e.g., x) and a second axis (e.g., y), that allows the device to specify positions in a plane.

Computer system 1200 may implement the techniques described herein using customized hard-wired logic, one or more ASICs or FPGAs, firmware, and/or program logic which in combination with the computer system causes or programs computer system 1200 to be a special-purpose machine. According to one embodiment, the techniques herein are performed by computer system 1200 in response to processor 1204 executing one or more sequences of one or more instructions contained in main memory 1206. Such instructions may be read into main memory 1206 from another storage medium, such as storage device 1210. Execution of the sequences of instructions contained in main memory 1206 causes processor 1204 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 1210. Volatile media includes dynamic memory, such as main memory 1206. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 1202. Transmission media can also take the form of acoustic or light waves, such as those generated during radio-wave and infra-red data communications.

Various forms of media may be involved in carrying one or more sequences of one or more instructions to processor 1204 for execution. For example, the instructions may initially be carried on a magnetic disk or solid-state drive of a remote computer. The remote computer can load the instructions into its dynamic memory and send the instructions over a network connection. A modem or network interface local to computer system 1200 can receive the data. Bus 1202 carries the data to main memory 1206, from which processor 1204 retrieves and executes the instructions. The instructions received by main memory 1206 may optionally be stored on storage device 1210 either before or after execution by processor 1204.

Computer system 1200 also includes a communication interface 1218 coupled to bus 1202. Communication interface 1218 provides a two-way data communication coupling to a network link 1220 that is connected to a local network 1222. For example, communication interface 1218 may be a network card, a modem, a cable modem, or a satellite modem to provide a data communication connection to a corresponding type of telephone line or communications line. Wireless links may also be implemented. In any such implementation, communication interface 1218 sends and receives electrical, electromagnetic, or optical signals that carry digital data streams representing various types of information.

Network link 1220 typically provides data communication through one or more networks to other data devices. For example, network link 1220 may provide a connection through local network 1222 to a host computer 1224 or to data equipment operated by an Internet Service Provider (ISP) 1226. ISP 1226 in turn provides data communication services through the world-wide packet data communication network now commonly referred to as the “Internet” 1228. Local network 1222 and Internet 1228 both use electrical, electromagnetic, or optical signals that carry digital data streams. The signals through the various networks and the signals on network link 1220 and through communication interface 1218, which carry the digital data to and from computer system 1200, are example forms of transmission media.

Computer system 1200 can send messages and receive data, including program code, through the network(s), network link 1220, and communication interface 1218. In the Internet example, a server 1230 might transmit a requested code for an application program through the Internet 1228, ISP 1226, local network 1222, and communication interface 1218. The received code may be executed by processor 1204 as it is received, and/or stored in storage device 1210, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method for populating a local object records database from a remote object records database, wherein an object record in the local object records database and/or the remote object records database represents information about an object having a geolocation and the geolocation of the object represented by the object record, wherein the local database is hosted on a mobile device and wherein geolocations represent locations relative to points and/or regions relative to a geographic range of the object records of the remote database, the method comprising the steps of:
determining a device geolocation state of the mobile device, wherein the device geolocation state corresponds at least to a device geolocation of the mobile device;
determining a first geographical search space as a function of at least the device geolocation and a pre-determined range threshold relative to the device geolocation;
querying the remote database for a localized subset of object records, wherein object records of the localized subset have corresponding geolocations that are within the first geographical search space;
obtaining a result set of object records in response to the querying;
populating the local database with the result set;
determining whether the result set comprises filterable object records, wherein an object record is a filterable object record if the object record includes a filter parameter;
comparing, for at least one filterable object record, where one exists in the result set, the filter parameter, and the device geolocation state; and
if the at least one filterable object record is present in the result set and the filter parameter does not match the device geolocation state, filtering the at least one filterable object record from the local database.

2. The method of claim 1, wherein the device geolocation state corresponds at least to the geolocation of the mobile device and/or an orientation direction of the mobile device.

3. The method of claim 1, wherein the first geographical search space comprises a two-dimensional representation of a point or area on a surface of Earth.

4. The method of claim 1, wherein at least one of the filterable object records includes a plurality of filter parameters.

5. The method of claim 1, wherein comparing the filter parameter and the device geolocation state comprises determining whether the device geolocation state matches within each constraint specified by the filter parameter.

6. The method of claim 5, wherein the constraint specified by the filter parameter of the at least one filterable object record is that a device-object distance determined between the device geolocation and the corresponding geolocation of the object represented by the at least one filterable object record is less than or equal to some maximum device-object distance.

7. The method of claim 5, wherein the constraint specified by the filter parameter of the at least one filterable object record is that the device geolocation is within a geographically-defined access area defined, at least in part, by the filter parameter.

8. The method of claim 7, wherein the geographically-defined access area is represented by a polygonal shape.

9. The method of claim 6, wherein the constraint specified by the filter parameter of the at least one filterable object record further constrains the object represented by the at least one filterable object record to have a corresponding geolocation within a limited range of angles around the object represented by the at least one filterable object record defined by an object access angle range.

10. The method of claim 9, further comprising:
filtering the local database based on a bearing of objects relative to the mobile device from a determined location of the mobile device to the location of those geolocated objects in the local database; and
comparing the bearing to access characteristics associated with any such geolocated objects that comprise an access characteristic.

11. The method of claim 10, further comprising:
filtering the local database by removing those geolocated objects from the local database if a determined bearing from the mobile device to the object indicates that the mobile device is outside the object access angle range of the object.

12. The method of claim 1, wherein filtering the at least one filterable object record from the local database comprises deleting the at least one filterable object record from the local database.

13. The method of claim 1, wherein filtering the at least one filterable object record from the local database comprises masking the at least one filterable object record to filter the at least one filterable object record from a subsequent local retrieval of object records.

14. The method of claim 1, wherein the filter parameter represents one or more of an access range limit, a geographically-defined closed area, and/or an object access angle range.

15. A non-transitory computer-readable storage medium storing instructions, which when executed by at least one processor of a computer system, causes the computer system to populate a local object records database from a remote object records database, wherein an object record in the local object records database and/or the remote object records database represents information about an object having a geolocation and the geolocation of the object represented by the object record, wherein the local database is hosted on a mobile device and wherein geolocations represent locations relative to points and/or regions relative to a geographic range of the object records of the remote database, the instructions comprising instructions for:
determining a device geolocation state of the mobile device, wherein the device geolocation state corresponds at least to a device geolocation of the mobile device;
determining a first geographical search space as a function of at least the device geolocation and a pre-determined range threshold relative to the device geolocation;
querying the remote database for a localized subset of object records, wherein object records of the localized subset have corresponding geolocations that are within the first geographical search space;
obtaining a result set of object records in response to the querying;
populating the local database with the result set;
determining whether the result set comprises filterable object records, wherein an object record is a filterable object record if the object record includes a filter parameter;
comparing, for at least one filterable object record, where one exists in the result set, the filter parameter, and the device geolocation state; and
if the at least one filterable object record is present in the result set and the filter parameter does not match the device geolocation state, filtering the at least one filterable object record from the local database.
